(19) United States
(12) Patent Application Publication
(10) Pub. No.: US 2024/0263395 A1
(43) Pub. Date: Aug. 8, 2024

(54) Refining Segment

(71) Applicant: Valmet Technologies, Inc., Espoo (FI)

(72) Inventor: Ville Ruola, Valkeakoski (FI)

(73) Assignee: Valmet Technologies, Inc., Espoo (FI)

(21) Appl. No.: 18/425,221

(22) Filed: Jan. 29, 2024

(30) Foreign Application Priority Data
Feb. 6, 2023 (FI) 20235106

(51) Int. Cl. D21D 1/24

(52) U.S. Cl. CPC D21D 1/24

(57) ABSTRACT

A refining segment (4) for a refiner (1) for refining lignocellulose-containing fibrous material has an inner end edge (20) and an outer end edge (21) opposite to the inner end edge. A refining surface (5) has refining bars (25) and refining grooves (26) therebetween and at least one recess (27, 27′, 27″) extending from the outer end edge of the refining segment at least partly towards the inner end edge for forming at least partly at least one backflow guide groove (28) extending from the outer end edge of the refining segment at least partly towards the inner end edge. A volume of the at least one recess is arranged to decrease towards the inner end edge for providing the volume of the at least one backflow guide groove to decrease towards the inner end edge.

### CROSS REFERENCES TO RELATED APPLICATIONS

This application claims priority on Finnish App. No. FI20235106, filed Feb. 6, 2023, the disclosure of which is incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The invention relates to the refining of fibrous material and especially to a refining segment for a refiner for refining lignocellulose-containing fibrous material.

Refiners used for refining fibrous material, such as refiners used for manufacturing mechanical pulp or in any low consistency refining, comprise typically two refining elements opposite to each other and turning relative to each other, i.e., one or both is/are rotating. The refining elements comprise refining surfaces provided with refining bars and refining grooves therebetween, the refining bars being intended to defiber and refine the material to be refined, i.e., pulp, and the refining grooves being intended to convey the material to be refined forward along the refining surfaces. The refining surface of the refining element is typically formed of several refining segments fastened to a body of the respective refining element, whereby the refining segments comprise refining surfaces provided with the refining bars and the refining grooves therebetween. In that case the complete refining surface of the refining element is thus formed of the refining surfaces of said several refining segments fastened next to each other in the refining element. An example of a refining segment like that is shown in FI-publication 126263 B, wherein the refining segment comprises a refining surface provided with refining bars and refining grooves therebetween and with specific feeding grooves extending from an inner end edge of the refining segment towards an outer end edge of the refining segment and intended to convey the material to be refined and the material already refined towards the outer edge of the refining segment, and thereby to increase a capacity of the refining. Alternatively, the refining segment may be a single uniform piece extending over a whole circumference of the respective refining element, whereby refining bars and refining grooves in a refining surface of this single uniform piece form the complete refining surface of the refining element. The refining segments of this type are also called refiner fillings.

All processes for manufacturing pulp from lignocellulosic material produce shives as an undesired quality problem. A shive is a particle or fiber bundle or wood fragment that is produced by incomplete splitting of wood material into fibers during cooking or mechanical treatment. The shives not only contaminate the quality of the produced pulp but also deteriorate operation of some processing devices such as refiners, wherein the shives have a tendency of blocking the refining surfaces and thereby degrading quality of the produce pulp and decreasing a capacity of the refiner. Therefore, there is a need for reducing an amount or a proportion of shives in the pulp.

### SUMMARY OF THE INVENTION

An object of the present invention is to provide a novel refining segment for refining fibrous material.

The invention is based on the idea of improving refining effect to be subjected to the fibrous material to be refined by collecting fibrous material, and shives therein, flowing backwards on the refining surface of the refining segment, and guiding the backward flowing fibrous material and shives therein in a controlled manner back into a refining gap in a refiner in order to achieve the expected refining effect.

The advantage of the invention is that the amount of the shives known as a by-product of fiber production and supposed to be removed during fiber processing will decrease without scarifying pulp properties, and in fact, other pulp quality parameters like strengths, formation and smoothness will improve when the amount of the shives in the pulp is reduced.

### BRIEF DESCRIPTION OF THE DRAWINGS

In the following the invention will be described in greater detail by means of preferred embodiments with reference to the accompanying drawings.

FIG. 1 shows schematically a fragmentary cross-sectional side view of a conical refiner comprising conical refining elements.

FIG. 2 shows schematically a stator refining segment seen obliquely from above.

FIG. 3 shows schematically an example of a test result of a practical refining experiment.

FIG. 4A shows schematically from above a second stator refining segment.

FIG. 4B shows schematically a side view of the refining segment of FIG. 4A in cross section.

FIG. 5A shows schematically from above a third stator refining segment;

FIG. 5B shows schematically a side view of the refining segment of FIG. 5A in cross section.

FIG. 6 shows schematically, seen obliquely from above, a set of fourth stator refining segments arranged next to each other.

FIG. 7 shows schematically a fifth stator refining segment seen obliquely from above.

For the sake of clarity, the figures show some embodiments of the invention in a simplified manner. Like reference numerals identify like elements in the figures.

### DESCRIPTION OF THE PREFERRED EMBODIMENTS

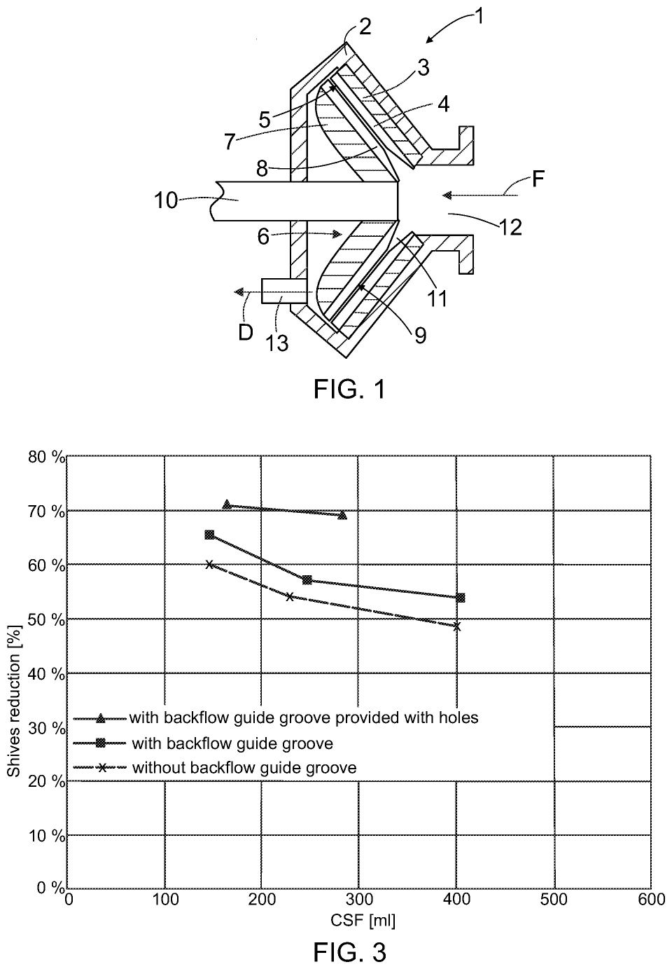

FIG. 1 is a schematic side view of a refiner 1 in cross-section. The refiner 1 may for example be used for refining lignocellulose-containing wood-based or plant-based fibrous material. The fibrous material to be refined in the refiner 1 has a form of pulp suspension, i.e., a mixture of water and fibrous material and possibly some additives. In a refining a consistency of the pulp suspension to be fed into the refiner 1 may vary according to the actual needs. A consistency of the pulp suspension to be fed into the refiner 1 may vary for example based on a raw material as well as on the intended end product. In low consistency refining applications, the consistency of the pulp suspension to be fed into the refiner 1 is typically less than 6%, and typically between 2.5% and 5.5%. In high consistency refining applications, the consistency of the pulp suspension to be fed into the refiner 1 is typically over 25%, and typically between 35% and 50%. The refining segment disclosed herein may be used both in low consistency refiners and in high consistency refiners. Furthermore, the refiner 1 shown in FIG. 1 is a conical refiner but disc refiners, conical-disc-refiners and cylindrical refiners could be used as well.

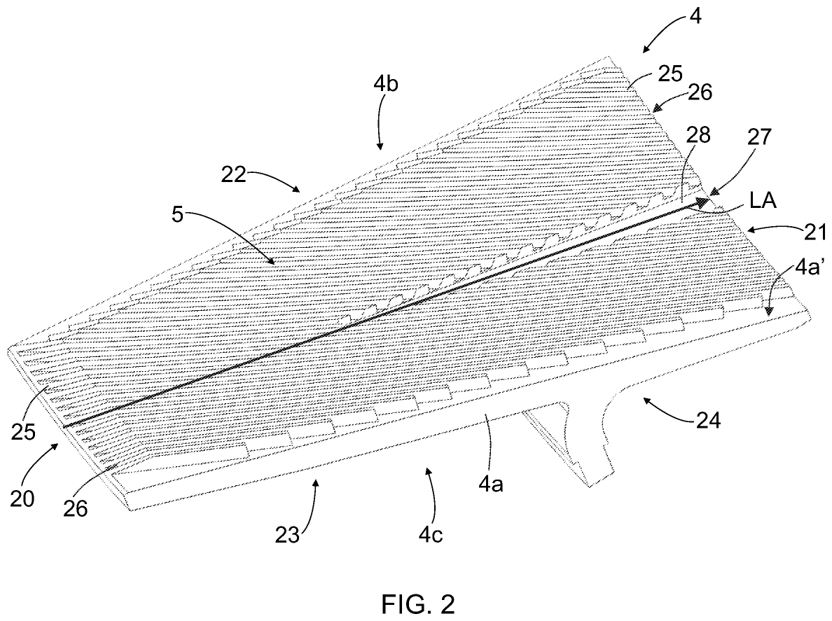

The refiner 1 of FIG. 1 comprises a frame 2 and a stationary stator 3 supported on the frame 2, the stator 3 forming a stationary refining element of the refiner 1. The stator 3 comprises two or more stator refining segments 4, each stator refining segment 4 extending only partly over a circumference of the stator 3. An example of the stator refining segment 4 like that is shown schematically in FIG. 2. The stator refining segment 4 comprises refining bars and refining grooves therebetween. The refining bars and the refining grooves in the stator refining segment 4 form a refining surface 5 of the respective refining segment 4, the refining surface 5 of each stator refining segment 4 thereby providing a part of a refining surface of the stator 3. A complete refining surface of the stator 3 is formed of the refining surfaces 5 of a necessary number of the stator refining segments 4 fastened next to each other in the stator 3 so that the complete refining surface 5 extending over the whole circumference of the stator 3 is provided. For the sake of clarity, both the refining surface of each single stator refining segment 4 as well as the complete refining surface of the stator 3 are herein denoted with the same reference sign 5.

The refiner 1 further comprises a rotor 6 of the refiner 1, the rotor 6 forming a rotatable refining element of the refiner 1. The rotor 6 comprises a rotor frame 7. The rotor frame 7 is connected to a rotatable shaft 10 used to rotate the rotor 6 about its central axis. The rotor 6 further comprises two or more rotor refining segments 8, each rotor refining segment 8 extending only partly over a circumference of the rotor 3. The rotor refining segment 8 may thus resemble for example the stator refining segment 4 shown schematically in FIG. 2. The rotor refining segments 8 are supported to the rotor frame 7 and each of them comprises refining bars and refining grooves therebetween. The refining bars and the refining grooves in the rotor refining segment 8 form a refining surface 9 of the respective refining segment 8, the refining surface 9 of each rotor refining segment 8 thereby providing a part of a refining surface of the rotor 6. A complete refining surface of the rotor 6 is formed of the refining surfaces 9 of a necessary number of the rotor refining segments 8 fastened next to each other in the rotor 6 so that the complete refining surface 9 extending over the whole circumference of the rotor 6 is provided. For the sake of clarity, both the refining surface of each single rotor refining segment 8 as well as the complete refining surface of the rotor 6 are herein denoted with the same reference sign 9.

Alternatively, the refining segment may also be a single uniform piece extending over a whole circumference of the stator 3 or the rotor 6, whereby refining bars and refining grooves in a refining surface of this single uniform piece form the complete refining surface of the stator 3 or the rotor 6.

The fibrous material to be refined is fed into the refiner 1, into a refining gap 11 remaining between the stator 2 and the rotor 6 opposite to each other via a feed channel 12 in a manner shown by arrow F. The refined material is removed via a discharge channel 13 from the refiner 1, as schematically shown by arrow D.

FIG. 2 shows schematically a stator refining segment 4 seen obliquely from above. The stator refining segment 4 comprises a body 4a, a front side 4b to be directed towards the refining gap 11 of the refiner 1, i.e., towards the rotor 6, and a backside 4c to be directed towards the frame 2 of the refiner 1.

The stator refining segment 4 of FIG. 2 is applicable to be used for forming a part of the refining surface 5 of the stator 3 of a conical refiner 1, whereby the complete refining surface 5 in the stator 3 is provided by arranging necessary number of the stator refining segments 4 of FIG. 2 next to each other around a circumference of the stator 3. The solution described in this description below is exemplified especially for the conical and disc-like stator refining segments 4 applicable to be used in the conical refiner 1, in a disc refiner or in a conical-disc-refiner but the solution may respectively be applied for rotor refining segments applicable to be used in the conical refiner 1, in a disc refiner or in a conical-disc-refiner and for stator and rotor refining segments applicable to be used in cylindrical refiners. Furthermore, the solution may respectively be applied for refining segments that extend over the whole circumference of the stator 3 or the rotor 6 as a one uniform piece.

The refining segment 4 comprises an inner end edge 20 or a first end edge 20 being intended to be directed towards an inner periphery of the stator 3. The refining segment 4 further comprises an outer end edge 21 or a second end edge 21 opposite to the inner end edge 20 in a longitudinal direction of the refining segment 4, the outer end edge 21 being intended to be directed towards an outer periphery of the stator 3. Generally, the refining segment has a longitudinal direction, or a longitudinal axis LA, extending from the inner end edge 20 up to the outer end edge 21, and a width direction transversal to the longitudinal axis. When mounted in a refiner the longitudinal axis LA of the refining segment is oriented in a substantially axial direction of the refiner in case of conical and cylindrical refiners and in a radial direction of the refiner in case of disc refiners. Furthermore, in conical refiners, typically, the radially smaller end of the stator/rotor is considered to refer to the inner periphery of the stator/rotor and the radially larger end of the stator/rotor is considered to refer to the outer periphery of the stator/rotor. In disc refiners, the part of the refining segment radially closest to a center of the refiner is considered to refer to the inner periphery of the stator/rotor and the part of the refining segment radially farthest away from the center of the refiner is considered to refer to the outer periphery of the stator/rotor.

The refining segment 4 further comprises a first side edge 22 extending from the inner end edge 20 of the refining segment 4 up to the outer end edge 21 of the refining segment 4. The refining segment 4 further comprises a second side edge 23 opposite to the first side edge 22 in a circumferential direction of the refining segment 4. The second side edge 23 extends from the inner end edge 20 of the refining segment 4 up to the outer end edge 21 of the refining segment 4. The inner 20 and the outer 21 end edges together with the first 22 and second 23 side edges contribute to define a periphery 27 of the refining segment 4. In refining segments that extend over the whole circumference of the stator 3 or the rotor 6 as the one uniform piece, there are not present any side edges of the refining segment but only the corresponding end edges 20, 21.

A front side of the refining segment 4 is provided with refining bars 25 and refining grooves 26 between the refining bars 25, the refining bars 25 and the refining grooves 26 together providing the refining surface 5 of the refining segment 4. The refining bars 25 are intended to defiber and refine the material to be refined and the refining grooves 26 are intended to convey the material to be refined between the refining bars 26 forward along the refining surface 5. The material to be refined is supplied onto the refining surface 5 over the inner end edge 20 of the refining segment 4 and the material already refined is discharged away from the refining surface 5 over the outer end edge 21 of the refining segment 4. Generally, a refining segment may have different patterns consisting of varying configuration of refining bars and refining grooves in order to provide certain performance according to the actual production needs, and the refining surface 5 of the refining segment 4 is shown in FIG. 2 in view of the refining bars 25 and the refining grooves 26 for a purpose of exemplary illustration only. The actual implementation of the refining surface 5 may thus vary in many ways. In the refining segment 4, an upper surface 4a′ of the refining segment 4 forms a bottom level of the refining bars 25 and the refining grooves 26. In other words, the upper surface 4a′ of the refining segment 4 forms bottoms, i.e., bottom surfaces, of the refining grooves 26.

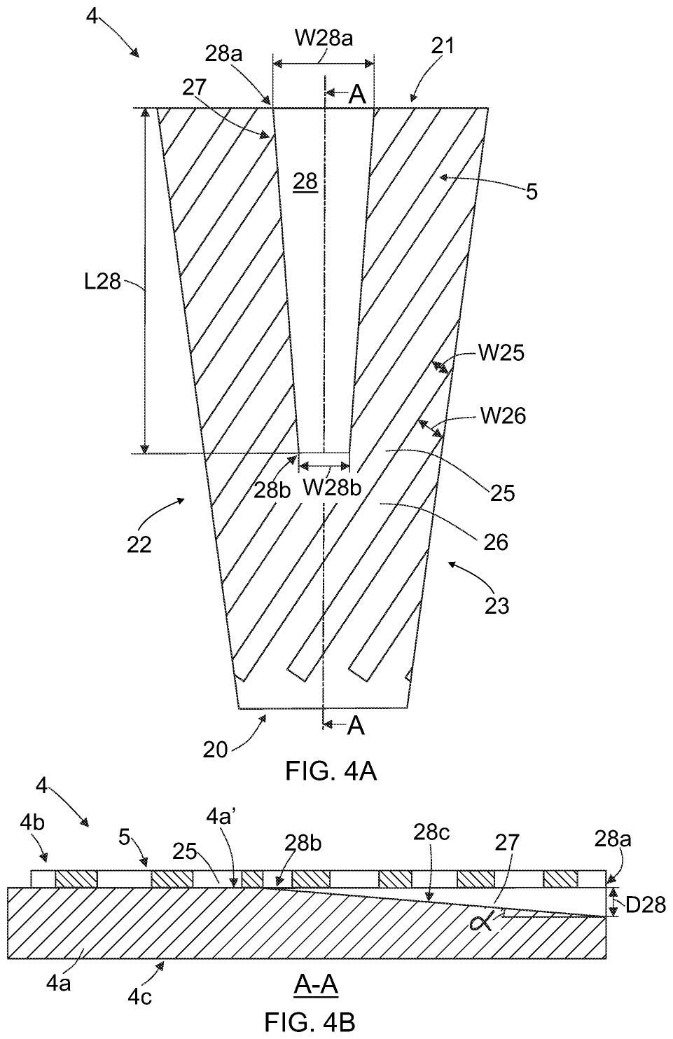

Dimensions of the refining bars 25 and the refining grooves 26 in the refining surface 5 of the stator refining segment 4 may vary in many ways for example based on a raw material to be refined as well as on an intended degree of refining or on the end product. Typically, a width W25 of the refining bar 25 is about 1.3-7 mm and a width W26 of the refining groove 26 is about 1.3-7 mm. A height of the refining bars 25, or in other words, a depth of the refining grooves 26 from a top of the refining bar 25 up to a bottom of the refining groove 26, is typically about 5-10 mm. Other ranges for the widths of the refining bars 25 and the refining grooves 26, as well as for the depth of the refining grooves 26 are, however, possible. The width W25 of the refining bar 25 and the width W26 of the refining groove 26 are disclosed schematically in FIG. 4A below. The dimensions of the refining bars and the refining grooves are typically the same in the respective rotor refining segment.

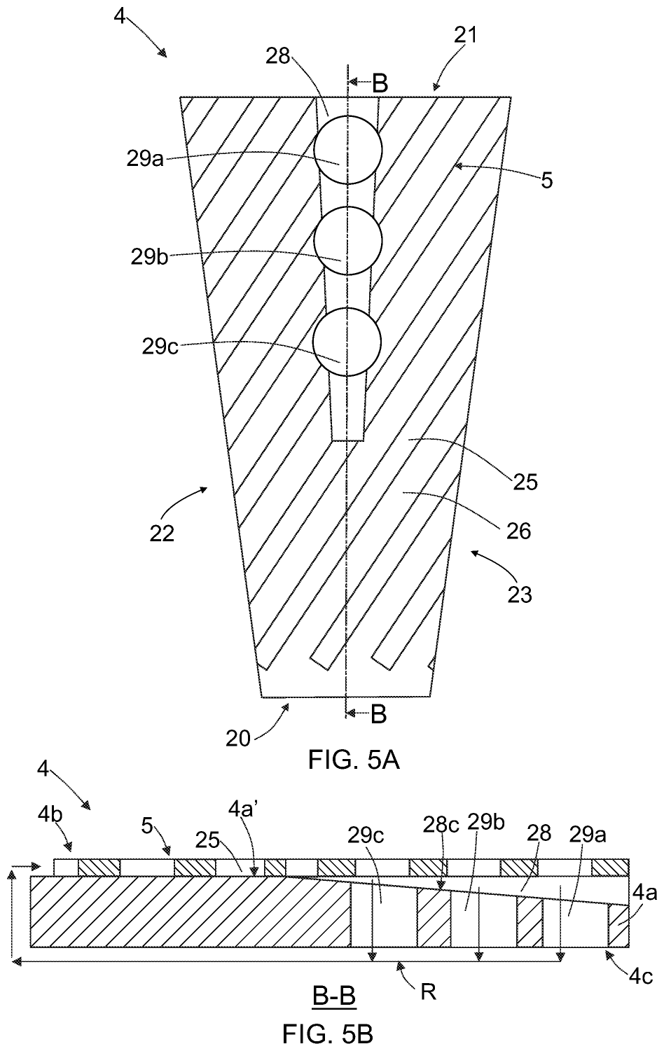

The refining segment 4 of FIG. 1 further comprises a recess 27 that extends from the outer end edge 21 of the refining segment 4 at least partly towards the inner end edge 20 of the stator refining segment 4 without extending up to the inner end edge 20 of the refining segment 4. The recess 27 forms a backflow guide groove 28 that extends from the outer end edge 21 of the refining segment 4 at least partly towards the inner end edge 20 of the refining segment 4 without, however, extending up to the inner end edge 20 of the refining segment 4. The recess 27 is formed in the body 4a of the refining segment 4 below the bottom level of the refining bars 25 and the refining grooves 26. A top level of the recess 27 is thus on the same level with the upper surface 4a′ of the body 4a of the refining segment 4, and a bottom, i.e., a bottom surface, of the recess 27 extends into the body 4a of the refining segment 4. This means that the recess 27, and the respective backflow guide groove 28, extends from the outer end edge 21 of the refining segment 4 at least partly towards the inner end edge 20 of the refining segment 4 in the body 4a of the refining segment 4, below the bottom level of the refining bars 25 and the refining grooves 26. The backflow refers to the flow of the fibrous material to be refined backwards on the refining surface of the refining segment, i.e., in a direction from the outer end edge of the refining segment towards the inner end edge of the refining segment, and the purpose of the backflow guide groove 28 is to guide that fibrous material and shives therein flowing backwards into the refining gap 11 to be refined. Furthermore, in a longitudinal direction of the recess 27 from the outer end edge 21 of the refining segment 4 towards the inner end edge 20 of the refining segment 4, a volume of the recess 27 is arranged to decrease towards the inner end edge 20 of the refining segment 4 for providing the volume of the backflow guide groove 28 to decrease towards the inner end edge 20 of the refining segment 4. In the example of FIG. 2, and later in the example of FIGS. 4A, 4B, 5A and 5B, the refining segment 4 comprises only one single backflow guide groove 28 but in practical embodiments the number of the backflow guide grooves 28 in the stator refining segment may also be higher than one. The recess 27 may be formed into the body 4a of the refining segment 4 either by removing material from the refining segment 4 or leaving the material out of the refining segment 4.

The purpose of use of the backflow guide groove 28 in the refining segment 4 is to collect fibrous material and shives therein flowing backwards on the refining surface 5 of the refining segment 4, i.e., flowing from the direction from the outer end edge 21 of the refining segment 4 towards the inner end edge 20 of the refining segment 4, and to further guide the backward flowing fibrous material and shives therein into the refining gap 11 to be refined. The guiding of the fibrous material and shives therein into the refining gap 11 takes place in response to the decreasing volume of the backflow guide groove 28 in the longitudinal direction thereof towards the inner end edge 20 of the refining segment 4. The decreasing volume of the backflow guide groove 28 thus forces the backward flowing fibrous material and shives therein into the refining gap 11 to be refined. This backflow of the fibrous material on the refining surface 5 of the refining segment 4 may take place for example in response to a pressure prevailing at the outer end edge 21 of the refining segment 4 being higher than a pressure prevailing at the inner end edge 20 of the refining segment 4, and the possible backflow is typically stronger on the stator side than the rotor side. The backflow guide groove 28 may extend up to the inner end edge 20 of the refining segment 4, but in case of the backflow guide groove 28 not extending up to the inner end edge 20 of the refining segment 4, possible disturbances in the feeding of the fibrous material to be refined into the refining gap 11 due to the fibrous material flowing backwards in the backflow guide groove possible up to the inner end edge 20 of the refining segment 4 may be avoided.

The effect of the backflow guide groove 28 is thus to guide or force the backward flowing fibrous material and shives therein into the refining gap 11 to be refined. The backflow control groove 28 also provides more open volume in the refining segment, providing thereby more mixing in the fibrous material on the refining surface of the refining segment. These effects of the backflow guide groove 28 provide that the amount of the shives will decrease without scarifying the pulp properties and other pulp quality parameters like strengths, formation and smoothness will also improve when the amount of the shives in the pulp is reduced.

FIG. 4A shows schematically from above a second stator re-fining segment 4, and FIG. 4B shows schematically a side view of the refining segment 4 of FIG. 4A in cross section. FIGS. 4A and 4B are shown for illustration of some characteristics of the backflow guide groove 28 in more detail and, for the sake of clarity, the dimensions of the refining bars 25, refining grooves 26 and the backflow guide groove 28 therein are highly exaggerated relative to the dimensions of the refining segment 4. Furthermore, the dimensions of the refining bars 25, refining grooves 26 and the backflow guide groove 28 are not also necessarily in scale relative to each other.

Referring to FIGS. 4A and 4B, the backflow guide groove 28 has a first end 28a at the outer end edge 21 of the refining segment 4 and a second end 28b facing towards the inner end edge 20 of the refining segment 4. The longitudinal direction of the backflow guide groove 28 is thus the direction of the groove from the first end 28a of the backflow guide groove 28 to the second end 28b of the backflow guide groove 28.

In the embodiment of FIGS. 2, 4A and 4B, the backflow guide groove 28 is straight and arranged to extend in its longitudinal direction in a substantially straight direction from the outer end edge 21 of the refining segment 4 towards the inner end edge 20 of the refining segment 4. In other words, in the embodiment of FIGS. 2, 4A and 4B a tangent of an imaginary center line of the backflow guide groove 28 extends in a substantially straight direction from the outer end edge 21 of the refining segment 4 towards the inner end edge 20 of the refining segment 4, i.e., at a position substantially parallel to the longitudinal direction or the longitudinal axis LA of the refining segment 4. In the embodiment like this the backflow guide groove 28 is considered to extend from the outer end edge 21 of the refining segment 4 substantially entirely towards the inner end edge 20 of the refining segment 4.

According to an alternative embodiment not shown in the figures, a straight backflow guide groove 28 may be arranged at an inclined position relative to the longitudinal direction or longitudinal axis LA of the refining segment 4, whereby the backflow guide groove 28 is arranged to extend in its longitudinal direction only partly towards the inner end edge 20 of the refining segment 4. In that case, differing from the embodiments of FIGS. 2, 4A and 4B, a tangent of an imaginary center line of the backflow guide groove 28 extends partly towards the inner end edge 20 of the refining segment 4 and partly towards one of the side edges 22, 23 of the refining segment 4, whereby the backflow guide groove 28 is considered to extend from the outer end edge 21 of the refining segment 4 only partly towards the inner end edge 20 of the refining segment 4. An angle between the center line of the backflow guide groove 28 and the longitudinal axis LA of the refining segment 4, i.e., between the tangent of the center line of the backflow guide groove 28 and the longitudinal axis LA of the refining segment 4, may for example be between 10 and 50 degrees along the longitudinal direction of the backflow guide groove 28.

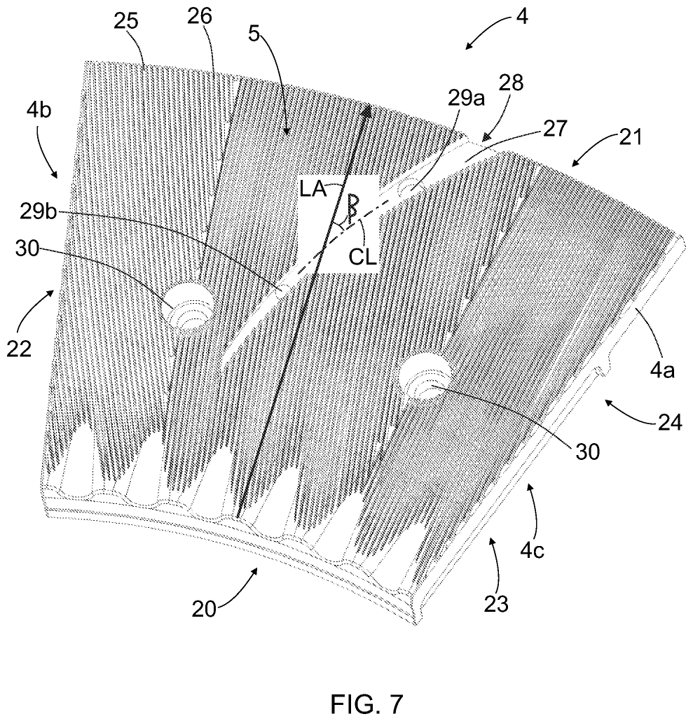

According to an alternative embodiment shown schematically below in FIG. 7, the backflow guide groove 28 is curved, whereby the backflow guide groove 28 is arranged to extend in its longitudinal direction in a curved manner from the outer end edge 21 of the refining segment 4 at least partly towards the inner end edge 20 of the refining segment 4. In that case, differing from the embodiments of FIGS. 2, 4A, 4B, 5A, 5B and 6, a tangent of an imaginary center line of the backflow guide groove 28 extends, at least at some points in the longitudinal direction of the backflow guide groove 28, only partly towards the inner end edge 20 of the refining segment 4 and partly towards one of the side edges 22, 23 of the refining segment 4, whereby the backflow guide groove 28 extends from the outer end edge 21 of the refining segment 4 only partly towards the inner end edge 20 of the refining segment 4.

According to the solution, the volume of the recess 27 is arranged to decrease towards the inner end edge 20 of the refining segment 4 for providing the volume of the backflow guide groove 28 to decrease towards the inner end edge 20 of the refining segment 4. The decreasing volume of the back-flow guide groove 28 towards the inner end edge 20 of the refining segment 4, i.e., towards the second end 28b of the backflow guide groove 28, may be implemented for example by at least one of the following ways: by decreasing a width of the recess 27 towards the inner end edge 20 of the refining segment 4, or by decreasing a depth of the recess 27 towards the inner end edge 20 of the refining segment 4. The decreasing volume of the backflow guide groove 28 towards the inner end edge 20 of the refining segment 4 may thus be implemented for example by decreasing the width and/or depth of the recess 27 towards the inner end edge 20 of the refining segment 4.

According to an embodiment, the width of the backflow guide groove 28 is arranged to decrease in its longitudinal direction in such a way that a width W28b of the backflow guide groove 28 at the second end 28b thereof is about 0%-95% of a width W28a of the backflow guide groove 28 at the first end 28a thereof. The width W28a of the backflow guide groove 28 at the first end 28a thereof may for example be about 5 mm-20 mm.

According to an embodiment, the depth of the backflow guide groove 28 is arranged to decrease in its longitudinal direction in such a way that a depth of the backflow guide groove 28 at the second end 28b thereof is smaller than a depth of the backflow guide groove 28 at the first end 28a thereof. The depth D28 of the backflow guide groove 28 is schematically illustrated in FIG. 4B at the first end 28a of the backflow guide groove 28. According to an embodiment, the depth D28 of the backflow guide groove 28 is arranged to decrease towards the second end 28b thereof such that a bottom 28c of the backflow guide groove 28, i.e., a bottom of the recess 27, is arranged to ascend from the first end 28a of the backflow guide groove 28 towards the second 28b end of the backflow guide groove 28 at an angle α of about 0.1-5 degrees for decreasing the volume of the backflow guide groove 28 towards the second end 28 of the back-flow guide groove 28. The depth of the backflow guide groove 28 at the first end 28a thereof may for example be about 3-10 mm below a bottom of the refining grooves 26. Thus, as said above, the recess 27, and thus the respective backflow guide groove 28, extends from the outer end edge 21 of the refining segment 4 at least partly towards the inner end edge 20 of the refining segment 4 in the body 4a of the refining segment 4 below the bottom level of the refining bars 25 and the refining grooves 26.

According to an embodiment, the recess 27, and thereby the backflow guide groove 28, is arranged to extend from the outer end edge 21 of the refining segment 4 to a distance of about 25% to 75% of a length of the refining segment 4 between the outer end edge 21 of the refining segment 4 and the inner end edge 20 of the refining segment 4. In other words, the backflow guide groove 28 is arranged to lie, from the outer end edge of the refining segment, at a portion of the refining segment that extends from the outer end edge 21 of the refining segment 4 up to about 25% to 75% of a measure of the refining segment 4 in a longitudinal direction thereof. The backflow guide groove 28 thus begins at the outer end edge 21 of the refining segment 4 and ends at some portion of the refining segment 4 between the outer 21 and inner 20 end edges of the refining segment 4. Referring to the example of FIG. 4A comprising the straight back-flow guide groove 28, this means that the length L28 of the straight backflow guide groove 28 is selected to be about 25% to 75% of the dimension of the refining segment 4 in the longitudinal direction of the refining segment 4. The higher the volume of the possible flow of the fibrous material backwards on the refining surface 5 of the stator refining segment 4, the more spacious backflow guide groove 28 may be selected for efficiently guiding the backflow of the fibrous material into the refining gap 11.

FIG. 5A shows schematically from above a third stator refining segment 4, and FIG. 5B shows schematically a side view of the refining segment 4 of FIG. 5A in cross section. The embodiment of FIGS. 5A and 5B is substantially similar to the embodiment of FIGS. 4A and 4B but, in addition to that, the embodiment of FIGS. 5A and 5B comprises holes 29a, 29b, 29c extending through the refining segment body 4a. The holes 29a, 29b, 29c are arranged in line with the backflow guide groove 28, whereby the holes 29a, 29b, 29c extend from the bottom 28c of the backflow guide groove 28 up to the backside 4c of the refining segment 4. For the sake of clarity, the dimensions of the holes 29a, 29b, 29c are not necessarily in scale but are exaggerated relative to other features in the refining segment.

The holes 29a, 29b 29c provides a possibility for at least a portion of the fibrous material flowing backwards in the backflow guide groove 28 to enter into the holes 29a, 29b, 29c and through the holes 29a, 29b, 29c to the back-side 4c of the refining segment 4, wherein the said portion of the fibrous material may flow up to the inner end edge 20 of the refining segment 4 and, at the inner end edge 20 of the refining segment 4, back into the refining gap 1 between the stator 3 and the rotor 6. This circulation of the fibrous material, as schematically shown in FIG. 5B with arrows denoted with the reference sign R, has the effect of causing the fibrous material to recirculate in the refiner and thereby to be subjected to the refining effect more than once.

According to an embodiment that is not shown in the figures, at least some of the holes 29a, 29b, 29c may be located at a center part of the refining segment 4, i.e., at a portion of the refining segment comprising the refining bars 25 and the refining grooves 26 but not in line with the backflow guide groove 28, whereby the described recirculation of the fibrous material may be increased.

In the embodiment of FIGS. 5A and 5B, the holes 29a, 29b, 29c are round. The shape, as well as a size of the holes may vary depending on the actual implementation of the refining segment 4, but typically the shape and size of the holes are constant in a single refining segment 4. The higher the number of the holes, and the higher the size of the holes, the more efficient recirculation effect can generally be provided but the number and size of the holes must, of course, be limited for example in view of structural durability of the refining segment 4 and the intended capacity of the refining, because the more there are holes, the shorter is a cutting edge length of the refining segment 4 and the less refining effect can be subjected to the fibrous material to be refined.

An example of the shives reduction in refining is shown schematically in a diagram of FIG. 3 that shows a test result of a practical experiment, wherein fibrous material was refined in a refiner comprising stator refining segments provided with backflow guide grooves 28 provided with openings 29a, 29b, 29c in the groove 28 (solid line with triangular identifiers), with back-flow guide grooves 28 without any openings 29a, 29b, 29c in the groove 28 (solid line with square identifiers), and without any backflow guide grooves (broken line with x-like identifiers), with otherwise similar refining surfaces. The horizontal axis of the diagram represents CSF (Canadian Standard Freeness) value of the fiber suspension in milliliters (ml) and vertical axis of the diagram represents shives reduction in percentages (%), measured according to ISO-standard ISO 5267. The diagram of FIG. 3 indicates a clear reduction in the amount of shives in the refined fibrous material when applying the stator refining segments provided with the backflow guide grooves 28. The reduction in the amount of shives was even more remarkable when the stator refining segments were provided with the holes 29a, 29b, 29b in line with the backflow guide grooves 28.

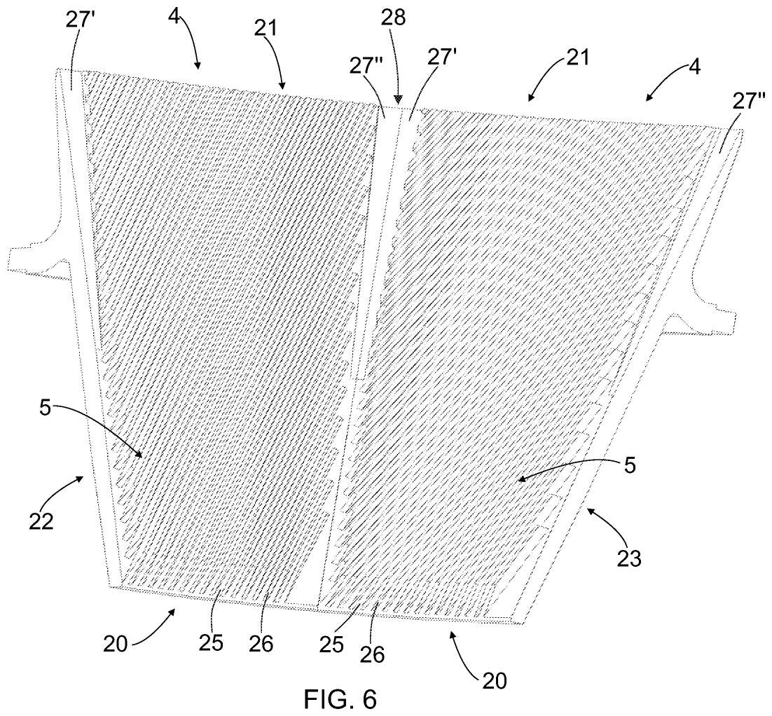

FIG. 6 shows schematically, seen obliquely from above, a set of fourth stator refining segments 4 arranged next to each other. The basic construction of the refining segments 4 of FIG. 6 is similar to that shown in FIG. 2 and discussed above, but instead of having a single recess 27 substantially in a middle section of the refining segment 4, the refining segments 4 of FIG. 6 comprise a first recess 27′ at the first side edge 22 of the refining segment 4 and a second recess 27″ at the second side edge 23 of the refining segment 4. The first recess 27′ and the second recess 27″ extend along the respective side edges 22, 23 of the refining segment 4 from the outer end edge 21 of the refining segment 4 towards the inner end edge 20 of the refining segment 4. Furthermore, volumes of the first 27′ and second 27″ recesses are arranged to decrease towards the inner end edge 20 of the refining segment 4.

When the refining surface 5 of the stator 3 are assembled, the refining segments 4 are arranged next to each other, whereby the first side edge 22 of a refining segment 4 will be set against the second side edge 23 of a neighboring refining segment 4, as shown in FIG. 6 by way of example with two neighboring refining segments 4. When the first side edge 22 of the refining segment 4 on the right is set against the second side edge 23 of the refining segment 4 on the left, the first recess 27′ in the refining segment 4 on the right and the second recess 27″ in the refining segment 4 on the left form together, at the connection of the refining segments 4, a backflow guide groove 28 extending from the outer end edges 21 of the refining segments towards the inner end edges 20 of the refining segment 4, wherein the volume of the backflow guide groove 28 is arranged to decrease towards the inner end edges 20 of the refining segments 4.

An advantage of the embodiment of the refining segment 4 shown in FIG. 6 is a uniform refining surface at the middle section of the refining segment 4, whereby a loss of the cutting edge length of the refining segment 4 is typically less than in the refining segment 4 wherein the backflow guide groove 28 lies on the middle section of the refining segment 4. Another advantage is an easier manufacturing of the refining segment 4, especially if also the holes are used in this position of the backflow guide groove 28.

FIG. 7 shows schematically a fifth stator refining segment 4 seen obliquely from above. The refining segment 4 of FIG. 7 is a flat or disc-like refining segment 4 applicable to be used in a disc refiner or in a conical-disc-refiner. The basic construction of the refining segment 4 of FIG. 7 is similar to that disclosed above. The refining segment 4 of FIG. 7 also comprises the recess 27 that forms the backflow guide groove 28. Furthermore, there are holes 29a, 29b in line with the backflow guide groove 28. FIG. 7 discloses also fastening openings 30 extending through the refining segment body 4a and intended to receive proper fastening members, such as bolts, for fastening the refining segment 4 to the frame 2 of the refiner 1.

In the embodiment of the refining segment 4 of FIG. 7, the backflow guide groove 28 is curved, whereby the backflow guide groove 28 is arranged to extend in its longitudinal direction in the curved manner from the outer end edge 21 of the refining segment 4 at least partly towards the inner end edge 20 of the refining segment 4, whereby a tangent of an imaginary center line CL of the backflow guide groove 28 extends, at least at some points in the longitudinal direction of the backflow guide groove 28, only partly towards the inner end edge 20 of the refining segment 4 and partly towards the first side edge 22 of the refining segment 4, whereby the backflow guide groove 28 extends from the outer end edge 21 of the refining segment 4 only partly towards the inner end edge 20 of the refining segment 4. An angle β between the center line CL of the backflow guide groove 28 and the longitudinal axis LA of the refining segment 4, i.e., between the tangent of the center line CL of the backflow guide groove 28 and the longitudinal axis LA of the refining segment 4 may vary in a range of for example between 10 and 50 degrees along the longitudinal direction of the back-flow guide groove 28.

It will be obvious to a person skilled in the art that, as the technology advances, the inventive concept can be implemented in various ways. The invention and its embodiments are not limited to the examples described above but may vary within the scope of the claims.

I claim:

1. A refining segment for a refiner for refining lignocellulose-containing fibrous material, the refining segment comprising:
an inner end edge and an outer end edge opposite to the inner end edge (20); and
a refining surface comprising refining bars and refining grooves therebetween;
wherein the refining surface of the refining segment comprises at least one recess extending from the outer end edge of the refining segment at least partly towards the inner end edge of the refining segment for forming at least partly at least one backflow guide groove extending from the outer end edge of the refining segment at least partly towards the inner end edge of the refining segment, and wherein a volume of the at least one recess is arranged to decrease towards the inner end edge of the refining segment for providing the volume of the at least one backflow guide groove to decrease towards the inner end edge of the refining segment.

2. The refining segment of claim 1, wherein the at least one recess is arranged to extend from the outer end edge of the refining segment at least partly towards the inner end edge of the refining segment without extending up to the inner end edge of the refining segment for forming the at least one backflow guide groove such that it that extends from the outer end edge of the refining segment at least partly towards the inner end edge of the refining segment without extending up to the inner end edge of the refining segment.

3. The refining segment of claim 1, wherein a width of the at least one recess is arranged to decrease towards the inner end edge of the refining segment for decreasing the volume of the backflow guide groove towards the inner end edge of the refining segment.

4. The refining segment of claim 3, wherein the at least one backflow guide groove has a first end at the outer end edge of the refining segment and a second end facing at least partly towards the inner end edge of the refining segment, and that a width of the second end of the at least one backflow guide groove is about 0-95% of a width of the first end of the backflow guide groove.

5. The refining segment of claim 3 wherein the width of the first end of the at least one backflow guide groove is about 5-20 mm.

6. The refining segment of claim 1 wherein a depth of the at least one recess is arranged to decrease towards the inner end edge of the refining segment for decreasing the volume of the backflow guide groove towards the inner end edge of the refining segment.

7. The refining segment of claim 6, wherein the at least one backflow guide groove has a first end at the outer end edge of the refining segment and a second end facing at least partly towards the inner end edge of the refining segment, and that a bottom of the backflow guide groove is arranged to ascend from the first end of the at least one backflow guide groove towards the second end of the backflow guide groove at an angle of about 0.1-5 degrees for decreasing the volume of the at least one backflow guide groove towards the inner end edge of the refining segment.

8. The refining segment of claim 6, wherein the depth of the at least one recess defining the at least one backflow guide groove at the first end thereof is about 3-10 mm below a bottom of the refining grooves.

9. The refining segment of claim 1 wherein the at least one backflow guide groove is arranged to extend from the outer end edge of the refining segment to a distance of 25% to 75% of a length of the refining segment between the outer end edge of the refining segment and the inner end edge of the refining segment.

10. The refining segment of claim 1, wherein the at least one backflow guide groove is substantially straight and arranged to extend in a substantially straight direction from the outer end edge of the refining segment towards the inner end edge of the refining segment.

11. The refining segment of claim 1 wherein the at least one backflow guide groove is curved and arranged to extend in a curved manner from the outer end edge of the refining segment towards the inner end edge of the refining segment.

12. The refining segment of claim 1 wherein the refining surface of the refining segment comprises holes extending through a blade segment body.

13. The refining segment of claim 12 wherein the holes are arranged in line with the at least one back-flow guide groove.

14. A refining segment for a refiner for refining lignocellulose-containing fibrous material, the refining segment comprising:
an inner end edge and an outer end edge opposite to the inner end edge (20); and
a refining surface comprising refining bars which project from a bottom level of refining grooves positioned between the refining bars; and
portions of the refining surface defining a backflow guide groove which is recessed below the refining bars of the refining surface, wherein the backflow guide groove extends from the outer end edge of the refining segment towards the inner end edge of the refining segment, wherein a cross-sectional area of the backflow guide groove decreases as it extends towards the inner end edge of the refining segment thereby guiding a backflow of fibrous material into a refining gap above the refining surface when the refining segment is positioned opposite another refining segment within a refiner.

15. The refining segment of claim 14, wherein the backflow guide groove extends from the outer end edge of the refining segment towards the inner end edge of the refining segment without extending up to the inner end edge of the refining segment.

16. The refining segment of claim 15, wherein the backflow guide groove has a centerline extending from a first end at the outer end edge of the refining surface towards a second end which is closer to the inner end edge, and wherein the backflow guide groove has a width defined perpendicular to the centerline, and wherein a first width at the first end is greater than a second width at the second end.

17. The refining segment of claim 16, wherein the width of the second end of the backflow guide groove is about 0-95% of the width of the first end of the backflow guide groove.

18. The refining segment of claim 14 wherein the backflow guide groove is recessed below the bottom level of the refining grooves, and wherein a depth of the at backflow guide groove decreases as it extends towards the inner end edge of the refining segment for decreasing the volume of the backflow guide groove towards the inner end edge of the refining segment.

19. The refining segment of claim 14 wherein portions of the refining segment define at least one hole extending through the backflow guide groove which allows the flow of fibrous material through the hole.

20. The refining segment of claim 15 wherein the refining segment comprise a first refining segment, and further comprising a second refining segment positioned alongside the first refining segment, and wherein the backflow guide groove is defined by a recessed portion of the first refining segment which extends along a recessed portion of the second refining segment.
